(19) United States
(12) Patent Application Publication
(10) Pub. No.: US 2026/0285279 A1
(43) Pub. Date: Sep. 24, 2026

(54) ELECTRIC BRAKING DEVICE

(71) Applicant: ADVICS CO., LTD., Kariya-shi, Aichi-ken (JP)

(72) Inventors: Yasutoshi KITAHARA, Kariya-shi, Aichi-ken (JP); Tomonori KATSUYAMA, Kariya-shi, Aichi-ken (JP)

(73) Assignee: ADVICS CO., LTD., Kariya-shi, Aichi-ken (JP)

(21) Appl. No.: 19/469,971

(22) PCT Filed: Mar. 29, 2024
(86) PCT No.: PCT/JP2024/013232

§ 371 Date: Sep. 26, 2025

(30) Foreign Application Priority Data
Mar. 30, 2023 (JP) 2023-056253

(51) Int. Cl. B60T 13/74; B60T 17/22; F16D 55/226; F16D 65/18; F16D 66/00; F16D 121/24; F16D 125/48; F16D 127/02; F16D 127/06

(52) U.S. Cl. CPC B60T 13/746; B60T 17/22; F16D 55/226; F16D 65/18; F16D 66/00; F16D 2066/003; F16D 2121/24; F16D 2125/48; F16D 2127/02; F16D 2127/06

(57) ABSTRACT

An electric braking device generates a braking force by pressing a friction member against a rotating member that rotates integrally with a wheel of a vehicle, and includes a rotating unit that is part of a transmission path of power from an electric motor to the friction member, and rotates in synchronization with the electric motor, and a rotation angle detecting unit that detects a rotation angle of the electric motor by detecting rotation of a detected portion provided at the rotating unit.

### TECHNICAL FIELD

The present disclosure relates to an electric braking device.

### BACKGROUND ART

Patent Literature 1 discloses an electric braking device including a rotation angle sensor that detects a position of a rotor of an electric motor, a lock mechanism having a ratchet wheel, and a power transmission mechanism for transmitting power of the electric motor to a pressing member.

### CITATION LIST

### Patent Literature

Patent Literature 1: JP 2015-108410 A

### SUMMARY

### Technical Problem

In the electric braking device, it has been studied to provide a rotation angle detecting unit for detecting a rotation angle of an electric motor on a substrate of a brake ECU. When the rotation angle detecting unit is provided on the substrate of the brake ECU, the detected portion may be provided separately from the rotor of the electric motor. The detected portion, the rotation angle sensor, the ratchet wheel, and the gear of the speed reduction member may be individually assembled, and the assembling process is complicated.

An object of an aspect of the present disclosure is to provide an electric braking device that is easily assembled.

### Solution to Problems

In order to solve the above problem, an electric braking device according to an aspect of the present disclosure generates a braking force on a wheel by pressing a friction member against a rotating member that rotates integrally with the wheel of a vehicle, the electric braking device includes a rotating unit that is part of a transmission path of power from an electric motor to the friction member and rotates in synchronization with the electric motor, and a rotation angle detecting unit that detects a rotation angle of the electric motor by detecting rotation of a detected portion provided at the rotating unit.

### Advantageous Effects

According to an aspect of the present disclosure, the electric braking device can be easily assembled.

### BRIEF DESCRIPTION OF DRAWINGS

FIG. 1 is a diagram illustrating a configuration of an electric braking device according to an embodiment of the present disclosure.

FIGS. 2A and 2B are a view used to describe a lock mechanism according to an embodiment of the present disclosure.

### DESCRIPTION OF EMBODIMENTS

### Configuration of Electric Braking Device

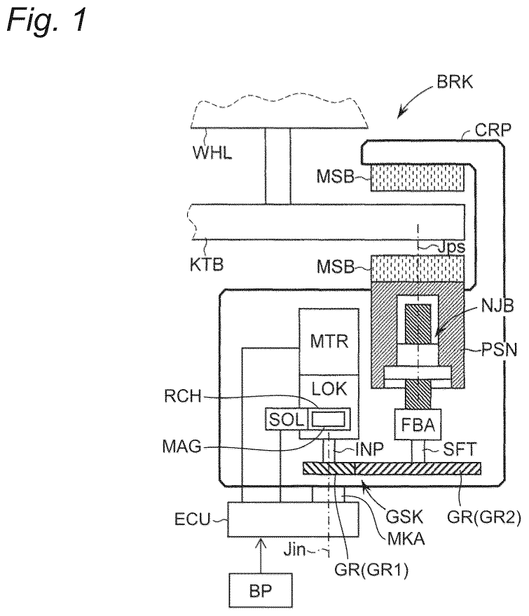

FIG. 1 is a diagram illustrating a configuration of an electric braking device according to an embodiment of the present disclosure.

An electric braking device BRK illustrated in FIG. 1 is mounted on a vehicle. A vehicle on which the electric braking device BRK is mounted includes a braking operation member BP such as a brake pedal, a wheel WHL, and a rotating member KTB that rotates integrally with the wheel WHL. The electric braking device BRK includes a caliper CRP, a detecting member MKA, and an electronic control unit ECU.

The caliper CRP illustrated in FIG. 1 is a floating electric caliper. The caliper CRP includes an electric motor MTR, a lock mechanism LOK, a speed reduction member GSK, a shaft SFT, a power conversion member NJB, a pressing member PSN, a pressing force acquisition unit FBA, and two friction members MSB.

The electric motor MTR is a power source for driving the pressing member PSN. The rotation of the electric motor MTR causes a power transmission member INP to rotate about a rotation axis Jin.

The speed reduction member GSK includes a plurality of speed reduction gears GR. The plurality of speed reduction gears GR includes a first gear GR1 fixed to the power transmission member INP and a second gear GR2 fixed to the shaft SFT. The speed reduction member GSK transmits the rotation of the power transmission member INP to the shaft SFT at a reduced rotation speed. The shaft SFT is rotatable about a rotation axis Jps.

The power conversion member NJB is, for example, a ball screw mechanism. The power conversion member NJB converts the rotational power of the shaft SFT into linear power to transmit the linear power to the pressing member PSN.

The pressing member PSN is, for example, a piston. The pressing member PSN moves in a direction parallel to the rotation axis Jps by the linear power transmitted from the power conversion member NJB, and presses the friction member MSB. The friction member MSB is disposed at a position facing the rotating member KTB that rotates integrally with the wheel WHL of the vehicle.

The pressing force acquisition unit FBA acquires a pressing force that is a force by which the pressing member PSN presses the friction member MSB.

The lock mechanism LOK is used for a parking brake of a vehicle and includes a ratchet wheel RCH and a solenoid SOL. The ratchet wheel RCH can rotate about the rotation axis Jin. The detected portion MAG is a magnet and is integrated with the ratchet wheel RCH of the lock mechanism LOK. The lock mechanism LOK will be described in detail later.

The detecting member MKA is a rotation angle detecting unit of a magnetic detection system, and detects a position or an orientation of the detected portion MAG. The detecting member MKA is disposed on a substrate of the electronic control unit ECU. The electronic control unit ECU can detect the rotation angle of the electric motor MTR based on the position or the direction of the detected portion MAG detected by the detecting member MKA. The electronic control unit ECU controls the electric motor MTR and the lock mechanism LOK based on the detected rotation angle of the electric motor MTR.

The rotation of the electric motor MTR is transmitted to the pressing member PSN by the speed reduction member GSK. When the electric motor MTR rotates in the forward rotation direction, the pressing member PSN presses the friction member MSB against the rotating member KTB. On the other hand, when the electric motor MTR rotates in the reverse rotation direction opposite to the forward rotation direction, the friction member MSB leaves the rotating member KTB.

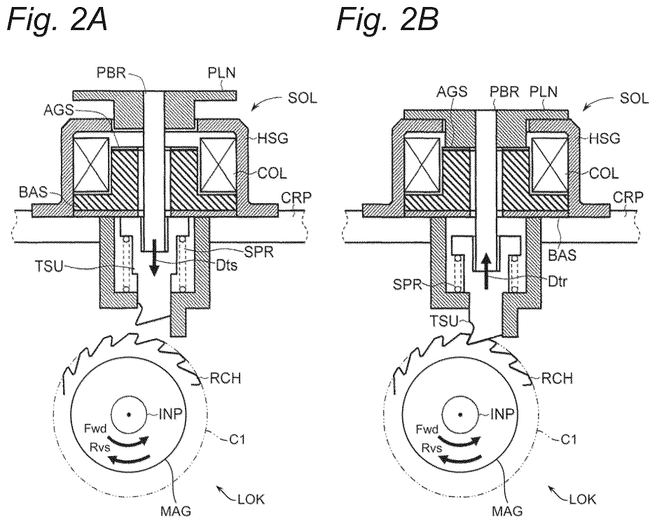

FIGS. 2A and 2B are a diagram used to describe the lock mechanism according to an embodiment of the present disclosure.

As illustrated in FIGS. 2A and 2B, the lock mechanism LOK includes the ratchet wheel RCH, the solenoid SOL, a pawl member TSU, and an elastic member SPR. The pawl member TSU can mesh with the tooth of the ratchet wheel RCH. FIG. 2A illustrates a state in which the pawl member TSU does not mesh with the ratchet wheel RCH. FIG. 2B illustrates a state in which the pawl member TSU meshes with the ratchet wheel RCH.

The ratchet wheel RCH is fixed to the power transmission member INP. The ratchet wheel RCH and the detected portion MAG are coaxial with the power transmission member INP in a side view of the ratchet wheel RCH. In the ratchet wheel RCH, when the rotation angle of the electric motor MTR is 0 degrees, a predetermined tooth can mesh with the pawl member TSU. In the ratchet wheel RCH, every time the rotation angle of the electric motor MTR rotates by a predetermined angle in a forward rotation direction Fwd, a predetermined tooth can mesh with the pawl member TSU. The ratchet wheel RCH has directionality in the tooth. The ratchet wheel RCH can rotate in the forward rotation direction but cannot rotate in the reverse rotation direction while meshing with the pawl member TSU.

The detected portion MAG is embedded in the ratchet wheel RCH. Therefore, the number of parts to be assembled is reduced, and the electric braking device BRK is easily assembled. In addition, the axial length of the power transmission member INP can be shortened.

The detected portion MAG is rotatable integrally with the ratchet wheel RCH. The detected portion MAG has a perfect circular shape in a side view of the ratchet wheel RCH, and has an N pole and an S pole. For example, the detected portion MAG has a semicircular N pole and S pole in a side view of the ratchet wheel RCH.

The detected portion MAG is disposed in a predetermined direction with respect to the ratchet wheel RCH. That is, when the ratchet wheel RCH is at a predetermined position, the positions of the N-pole and the S-pole of the detected portion MAG are determined in advance. The detecting member MKA can detect an angle change of the ratchet wheel RCH by detecting the position of the detected portion MAG, and can detect the rotation angle of the electric motor MTR.

The elastic member SPR is, for example, a spring. The elastic member SPR biases the pawl member TSU in a release direction Dtr in which the pawl member TSU is away from the ratchet wheel RCH.

The solenoid SOL is disposed at a position facing an addendum circle C1 of the ratchet wheel RCH. The solenoid SOL is a pull solenoid, and includes a coil COL, a base (fixed iron core) BAS, a plunger (movable iron core) PLN, a push bar PBR, a housing HSG, and an air gap spacer AGS.

The coil COL and the base BAS are accommodated in the housing HSG. The housing HSG is fixed to the caliper CRP.

One end of the push bar PBR is connected to the pawl member TSU, and the other end is fixed to the plunger PLN.

When a current flows through the winding wire of the coil COL, a magnetic field is generated. When a magnetic field is generated in the coil COL, the base BAS attracts the plunger PLN in a meshing direction Dts. The meshing direction Dts is a direction opposite to a release direction Dtr in which the elastic member SPR biases the pawl member TSU. The force with which the base BAS attracts the plunger PLN is stronger than the biasing force of the elastic member SPR. When the plunger PLN is attracted by the base BAS against the biasing force of the elastic member SPR, the pawl member TSU protrudes in the meshing direction Dts toward the ratchet wheel RCH and meshes with the ratchet wheel RCH as illustrated in FIG. 2B. On the other hand, when no current flows through the coil COL, the pawl member TSU moves in the release direction Dtr by the biasing force of the elastic member SPR, and the meshing with the ratchet wheel RCH is released as illustrated in FIG. 2A. The air gap spacer AGS is provided between the plunger PLN and the base BAS.

When the lock mechanism LOK is in the state of FIG. 2A, the lock mechanism LOK allows the power transmission member INP to rotate in the forward rotation direction Fwd and a reverse rotation direction Rvs.

When the electric motor MTR rotates in the forward rotation direction Fwd, the power transmission member INP, the ratchet wheel RCH fixed to the power transmission member INP, and the first gear GR1 of the speed reduction member GSK rotate in the forward rotation direction Fwd. The rotation of the electric motor MTR is transmitted to the shaft SFT by the speed reduction member GSK. The rotational power of the shaft SFT is converted into linear power by the power conversion member NJB. With this linear power, the pressing member PSN presses the friction member MSB against the rotating member KTB.

When the electric motor MTR rotates in the reverse rotation direction, the power transmission member INP, the ratchet wheel RCH fixed to the power transmission member INP, and the first gear GR1 of the speed reduction member GSK rotate in the reverse rotation direction Rvs. The rotation of the electric motor MTR is transmitted to the shaft SFT by the speed reduction member GSK.

The rotational power of the shaft SFT is converted into linear power by the power conversion member NJB. The linear power causes the friction members MSB to leave the rotating member KTB.

When the lock mechanism LOK is in the state of FIG. 2A, the detected portion MAG integrated with the ratchet wheel RCH rotates integrally with the power transmission member INP. The detecting member MKA can appropriately detect the rotation angle of the electric motor MTR by detecting the position of the detected portion MAG.

While the vehicle is parked, the lock mechanism LOK is in the state illustrated in FIG. 2B, and the stop state of the vehicle is maintained. When the lock mechanism LOK is in the state illustrated in FIG. 2B, the lock mechanism LOK allows the power transmission member INP to rotate in the forward rotation direction Fwd but restrains the power transmission member INP from rotating in the reverse rotation direction Rvs.

While the vehicle is parked, the power transmission member INP and the detected portion MAG do not rotate in the reverse rotation direction Rvs due to the restraint of the lock mechanism LOK. Therefore, even when the lock mechanism LOK is in the state of FIG. 2B, the detecting member MKA can appropriately detect the rotation angle of the electric motor MTR by detecting the position of the detected portion MAG.

### [Modification]

In the above embodiment, the detected portion MAG is a magnet having a semicircular N pole and S pole and having a perfect circular shape as a whole in a side view of the ratchet wheel RCH, when seen from the side face, but the disclosure is not limited thereto. As long as the N-pole and the S-pole are provided on the face facing the detecting member MKA, the detected portion MAG may not have a perfect circular shape.

In addition, the detected portion MAG may be provided on a gear other than the ratchet wheel RCH. For example, the detected portion MAG may be provided at the first gear GR1 or the second gear GR2 of the speed reduction member GSK.

In the above embodiment, the detected portion MAG and the detecting member MKA are the rotation angle detecting unit of the magnetic detection system, but the disclosure is not limited thereto. The detected portion MAG and the detecting member MKA may be a rotation angle detecting unit of any system such as a capacitance system.

### [Summary]

An electric braking device according to an aspect of the present disclosure generates a braking force on a wheel by pressing a friction member against a rotating member that rotates integrally with the wheel of a vehicle, the electric braking device includes a rotating unit that is part of a power transmission path of power from an electric motor to the friction member and rotates in synchronization with the electric motor, and a rotation angle detecting unit that detects a rotation angle of the electric motor by detecting rotation of a detected portion provided at the rotating unit.

In the electric braking device according to an aspect of the present disclosure, the electric motor generates the power to press the friction member against the rotating member by rotating in a first direction, and wherein the rotating unit is a ratchet wheel that restrains the electric motor from rotating in a second direction opposite to the first direction when the vehicle is stopped.

In the electric braking device according to an aspect of the present disclosure, the rotating unit is a speed reduction gear that reduces a rotation speed of rotation of the electric motor.

In the conventional electric braking device, since the rotation angle sensor, the detected portion whose position is detected by the rotation angle sensor, the ratchet wheel, and the gear of the speed reduction mechanism are individually disposed, the assembling process is complicated. According to the present disclosure, since the detected portion is integrated with the ratchet wheel or the gear of the speed reduction mechanism, easy assembly can be achieved.

The electric braking device according to an aspect of the present disclosure further includes a pawl member capable of meshing with the ratchet wheel, wherein the electric motor is allowed to rotate in the first direction and the second direction when the ratchet wheel does not mesh with the pawl member, and the ratchet wheel and the detected portion integrally rotate in a direction in which the electric motor rotates, and wherein the electric motor is restrained from rotating in the second direction when the ratchet wheel meshes with the pawl member.

According to the present disclosure, the rotation angle detecting unit can grasp the relative position of the teeth of the ratchet wheel with respect to the rotation angle of the electric motor regardless of the meshing between the ratchet wheel and the pawl member.

### [Additional Remark]

The present disclosure is not limited to the above-described embodiments, and various modifications can be made within the scope indicated in the claims, and embodiments obtained by appropriately combining technical means disclosed in different embodiments are included in the technical scope of the present disclosure.

1. An electric braking device that generates a braking force on a wheel by pressing a friction member against a rotating member that rotates integrally with the wheel of a vehicle, the electric braking device comprising:
a rotating unit that is part of a transmission path of power from an electric motor to the friction member and rotates in synchronization with the electric motor; and
a rotation angle detecting unit that detects a rotation angle of the electric motor by detecting rotation of a detected portion provided in the rotating unit.

2. The electric braking device according to claim 1, wherein
the electric motor generates the power to press the friction member against the rotating member by rotating in a first direction, and wherein
the rotating unit is a ratchet wheel that restrains the electric motor from rotating in a second direction opposite to the first direction when the vehicle is stopped.

3. The electric braking device according to claim 1, wherein the rotating unit is a speed reduction gear that reduces a rotation speed of rotation of the electric motor.

4. The electric braking device according to claim 2, further comprising:
a pawl member capable of meshing with the ratchet wheel, wherein
the electric motor is allowed to rotate in the first direction and the second direction when the ratchet wheel does not mesh with the pawl member, and the ratchet wheel and the detected portion integrally rotate in a direction in which the electric motor rotates, and wherein
the electric motor is restrained from rotating in the second direction when the ratchet wheel meshes with the pawl member.
